(19) United States
(12) Patent Application Publication
(10) Pub. No.: US 2003/0016329 A1
(43) Pub. Date: Jan. 23, 2003

(54) Making a liquid crystal display using heat and pressure lamination of liquid crystal coating

(75) Inventors: Thomas M. Smith, Spencerport, NY (US); Stanley W. Stephenson, Spencerport, NY (US); John I. Kilburn, Hilton, NY (US); John W. Boettcher, Webster, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/915,614

(22) Filed: Jul. 21, 2001

(51) Int. Cl. G02F 1/13

(52) U.S. Cl. 349/187

(57) ABSTRACT

A method of making a liquid crystal display, including the steps of providing a substrate; providing a first electrode over the substrate; coating the first electrode with aqueous dispersed material which when dried provides a protective dielectric layer over the first electrode; coating the dielectric layer with liquid crystal bearing material and drying such liquid crystal bearing material; providing a second substrate having a second electrode; and laminating the second electrode to the liquid crystal layer using heat and pressure only.

### CROSS REFERENCE TO RELATED APPLICATIONS

Reference is made to commonly assigned U.S. patent application Ser. No. 09/379,776, filed Aug. 24, 1999 entitled “Forming A Display Having Conductive Image Areas Over A Light Modulating Layer” by Dwight J. Petruchik et al., U.S. patent application Ser. No. 09/723,389, filed Nov. 28, 2000, entitled “Unipolar Drive for Cholesteric Liquid Crystal Displays” by David M. Johnson et al., U.S. patent application Ser. No. 09/______, filed concurrently herewith, entitled “A Dielectric Layer For Dispersed Liquid Crystal Layer” by Stephenson et al and U.S. patent application Ser. No. 09/______, filed concurrently herewith, entitled “Method of Making Liquid Crystal Display Having a Dielectric Adhesive Layer For Laminating a Liquid” by Smith et al, the disclosures of which are incorporated herein by reference.

### FIELD OF THE INVENTION

The present invention relates to a lamination process for polymer dispersed liquid crystal displays.

### BACKGROUND OF THE INVENTION

Currently, information is displayed using assembled sheets of paper carrying permanent inks or displayed on electronically modulated surfaces such as cathode ray displays or liquid crystal displays. Other sheet materials can carry magnetically writable areas to carry ticketing or financial information, however magnetically written data is not visible.

A structure is disclosed in PCT/WO 97/04398, entitled “Electronic Book With Multiple Display Pages” which is a thorough recitation of the art of thin, electronically written display technologies. Disclosed is the assembling of multiple display sheets that are bound into a “book”, each sheet is arranged to be individually addressed. The patent recites prior art in forming thin, electronically written pages, including flexible sheets, image modulating material formed from a bi-stable liquid crystal system, and thin metallic conductor lines on each page.

Fabrication of flexible, electronically written display sheets are disclosed in U.S. Pat. No. 4,435,047. A first sheet has transparent ITO conductive areas and a second sheet has electrically conductive inks printed on display areas. The sheets can be glass, but in practice have been formed of Mylar polyester. A dispersion of liquid crystal material in a binder is coated on the first sheet, and the second sheet is bonded to the liquid crystal material. Electrical potential applied to opposing conductive areas operate on the liquid crystal material to expose display areas. The display uses nematic liquid crystal material which ceases to present an image when de-energized.

U.S. Pat. No. 5,223,959 discloses a plurality of polymer dispersed liquid crystal material, each having a different dye material of red, green or blue dye material. Differing electrical signals to common electrodes operate on each of the materials to control the state of each type of dyed liquid crystal material. The patent requires the use of conventional nematic liquid crystals with a dye to absorb light. The droplets are chemically treated to be stable in either a clear or a light absorbing state. The invention also requires materials having different response times to electrical signals. The device must be continually driven so that the human eye perceives complementary colors. This arrangement has the disadvantage of requiring continuous, high speed electrical drive because the materials do not maintain their state. The material must be driven to achieve a neutral color density.

U.S. Pat. No. 5,437,811 discloses a light-modulating cell having a polymer dispersed chiral nematic liquid crystal. The chiral nematic liquid crystal has the property of being driven between a planar state reflecting a specific visible wavelength of light and a light scattering focal-conic state. Said structure has the capacity of maintaining one of the given states in the absence of an electric field.

U.S. Pat. No. 3,816,786 discloses droplets of cholesteric liquid crystal in a polymer matrix responsive to an electric field. The electrodes in the patent can be transparent or non-transparent and formed of various metals or graphite. It is disclosed that one electrode must be light absorbing and it is suggested that the light absorbing electrode be prepared from paints contains conductive material such as carbon.

U.S. Pat. No. 5,289,300 discusses forming a conductive layer over a liquid crystal coating to form a second conductor. The description of the preferred embodiment discloses Indium-Tin-Oxide (ITO) over a liquid crystal dispersion to create a transparent electrode.

Prior art discloses the use of dielectric barrier layers formed over ITO conductors. The dielectric layer protects the ITO transparent conductor from damage from electrochemical interaction with the light modulating material. The protective layers are typically formed by vacuum sputtering silicon dioxide over the ITO conductors. The vacuum forming process is slow and expensive.

### SUMMARY OF THE INVENTION

It is an object of this invention to provide an effective lamination process that does not require an adhesive layer and can be used to manufacture liquid crystal displays.

This object is achieved in a method of making a liquid crystal display, comprising the steps of:

(a) providing a substrate;

(b) providing a first electrode over the substrate;

(c) coating the first electrode with aqueous dispersed material which when dried provides a dielectric layer over the first electrode;

(d) coating the dielectric layer with liquid crystal bearing material and drying such liquid crystal bearing material;

(e) providing a second separate substrate;

(f) providing a second electrode over the second substrate; and

(g) laminating the second electrode to the coated liquid crystal bearing material using heat and pressure only.

The invention provides an inexpensive, efficient method of producing a durable bond between the components of a liquid crystal display. Such laminations permit the fabrication of electronic privacy screens having long life and durability.

### BRIEF DESCRIPTION OF THE DRAWINGS

FIG. 1 is a sectional view of a sheet having a coated liquid crystal in accordance with the present invention;

FIG. 2 is a plot of a distribution of domain size for aqueous dispersed liquid crystal;

FIG. 3A is a sectional view a sheet having a coated emulsion before drying;

FIG. 3B is a sectional view of a sheet having a coated emulsion after drying;

FIG. 4A is a sectional view of a nematic liquid crystal without an applied electric field;

FIG. 4B is a sectional view of a nematic liquid crystal with an applied electric field;

FIG. 5A is a display sheet having a laminated second conductor in accordance with prior art; and

FIG. 5B is a display sheet having a laminated second conductor in accordance with this invention.

### DETAILED DESCRIPTION OF THE PREFERRED EMBODIMENT

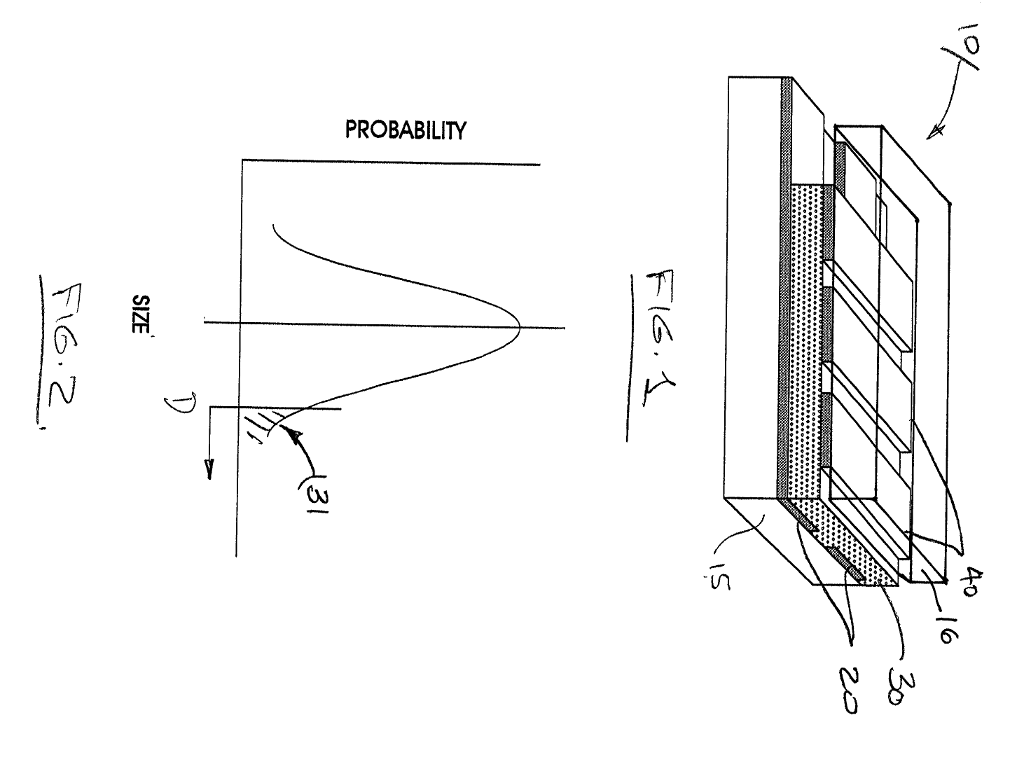

FIG. 1 is an isometric partial view of a new structure for a liquid crystal display shown as a sheet 10 made in accordance with the invention. It will be understood that other forms of media such as a more permanent display can also be used in accordance with the present invention. Sheet 10 includes a flexible substrate 15, which is a thin transparent polymeric material, such as Kodak Estar film base formed of polyester plastic that has a thickness of between 20 and 200 microns. In an exemplary embodiment, substrate 15 can be a 125-micron thick sheet of polyester film base. Other polymers, such as transparent polycarbonate, can also be used.

First electrode 20 is formed over substrate 15. First electrode 20 can be tin oxide or indium tin oxide (ITO), with ITO being the preferred material. Typically the material of first electrode 20 is sputtered as a uniform and continuous layer over substrate 15 having a resistance of less than 250 ohms per square.

A light modulating layer 30 which preferably is a polymer dispersed liquid crystal layer overlays first patterned electrode 20. This light modulating layer 30 is formed by coating liquid crystal bearing material and drying such liquid crystal bearing material. In a first case, the liquid crystal material is a nematic liquid crystal. Cholesteric liquid crystal materials can be Merck BL12, BL48, available from EM Industries of Hawthorne, N.Y. Such materials have high anisotropy indices of diffraction, which can act as a light diffusing surface in the absence of an electric field and as a transparent sheet 10 in the presence of an electric field.

In a second case the liquid crystal is a cholesteric liquid crystal, having peak reflection from the infrared through the visible spectrum. Application of electrical fields of various intensities and duration can drive a chiral nematic material (cholesteric) into a reflective, a transmissive state or an intermediate state. These materials have the advantage of maintaining a given state indefinitely after the field is removed. Cholesteric liquid crystal materials can be Merck BL112, BL118 or BL126, available from EM Industries of Hawthorne, N.Y.

Second electrode 40 is formed over second substrate 16. Second substrate 16 can be formed of the same material and way as the first substrate 15 is formed. This structure is bonded to the polymer dispersed light modulating layer 30 using both heat and pressure. Second electrode 40 should have sufficient conductivity to carry a field across light modulating layer 30. Indium tin oxide coatings permit second electrode 40 to be transparent and allow for bonding to gelatin-containing liquid crystal layers.

The dispersion of liquid crystals in aqueous suspension is done in any conventional manner. One method is to disperse liquid crystal oils in deionized water containing dissolved gelatin. Such compounds are machine coatable on equipment associated with photographic films. FIG. 2 is a plot of the dispersions of domain size for a liquid crystal oil in aqueous suspension. The oil domains have a size distribution around a mean diameter. A certain number are above a certain diameter D, and are called oversized domains 31.

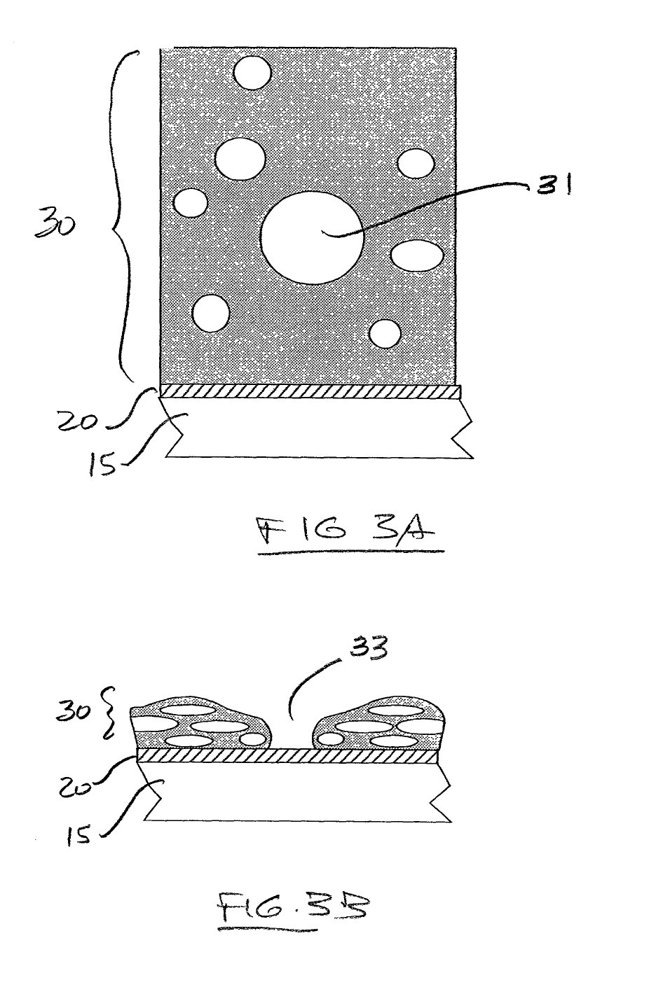

FIG. 3A is a section view of a typical liquid crystal oil dispersed in water coated over first electrode 20 and containing oversized liquid crystal oil domains 31. Such coatings are dried to remove water from the suspension. FIG. 3B is a section view of the dried coating. The liquid crystal material is encapsulated by the water-soluble binder to create a pressure resistant light modulating layer 30. Oversize oil domains 31 can be significantly larger in diameter than the dry thickness of light modulating layer 30. Oversized oil domains 31 create coating defects 33 in the light modulating layer 30.

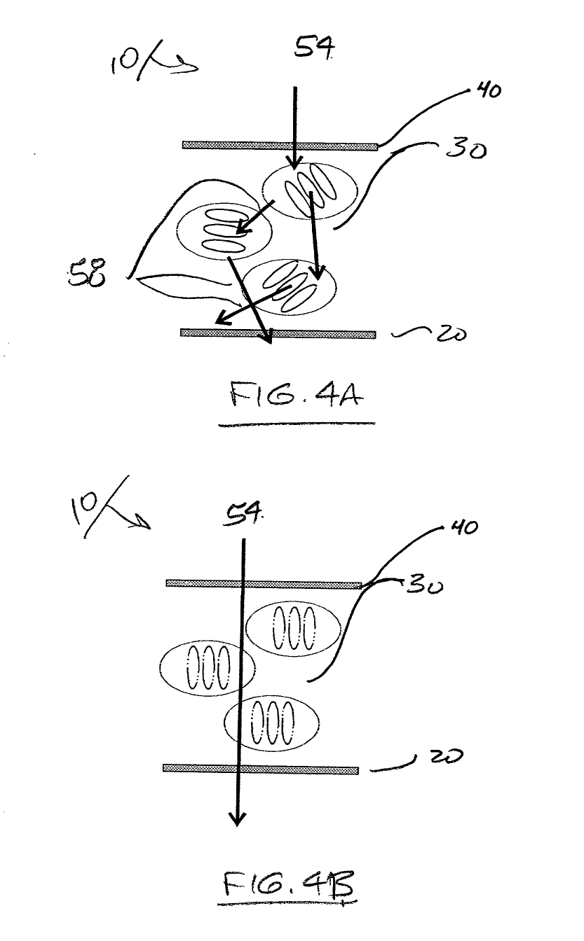

FIG. 4A is a sectional view of a first, privacy screen light modulating layer 30, which is a nematic liquid crystal material having high optical anisotropy. It has been found that 2-micron diameter domains of the liquid crystal in aqueous suspension converts incident light 54 into scattered light 58 in the absence of light modulating layer 30 within an electric field. In this case, sheet 10 can be used as a privacy screen. The material is further provided with first electrode 20 and second electrode 40 on either side of light modulating layer 30 so that an electrical field can be applied across the material. FIG. 4B is a sectional view of light modulating layer 30 with an electrical field applied. Liquid crystal material within each domain is aligned by the electrical field, and sheet 10 will becomes transparent. Electrically switching between the light scattering and transparent state using an electric field provides an electrically switched privacy screen.

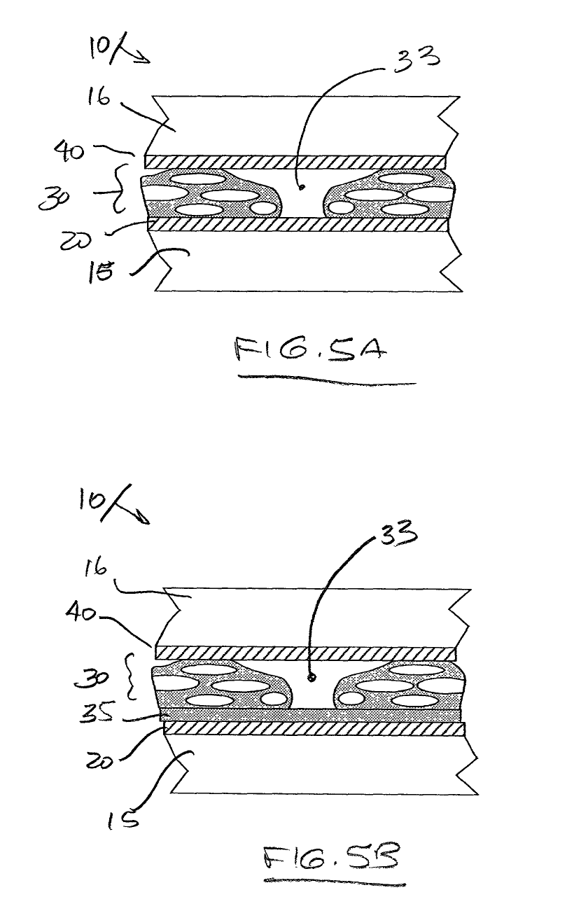

FIG. 5A is a sectional view of a privacy screen sheet 10 built in accordance with prior art. A second substrate 16, having second electrode 40 is bonded to a substrate 15 having a first electrode 20 and the light modulating layer 30. One method of bonding the two sheets of the privacy screens is to utilize an adhesive layer to bond second electrode 40 to light modulating layer 30. Coating defect 33 creates an air filled cavity in sheet 10. When sheets 10, formulated for privacy screen window application, are manufactured and a field is applied, liquid crystals in light modulating layer 30 begins to permanently align in the transparent state, even in the absence of a field.

FIG. 5B is a sectional view of a sheet built in accordance with the current invention. A protective layer 35 is aqueous coated over first electrode 20. The protective layer 35 was created by coating a 1.3% deionized gelatin solution at a rate of 0.38 cc per square meter. The resulting coating was about 0.5 microns thick. An emulsion of high anisotropy liquid crystal in a gel-water solution was coated over an ITO coated sheet of polyester. A second polyester substrate 16, also having an ITO coated surface 40 was thermally bonded to the light modulating layer 30. Lamination of the layers can be achieved using a heated nip providing interfacial temperatures of 90-120° C. and moderate pressure. The required roll temperature will depend upon thickness and thermal conductivity of substrates as well as lamination speed. The bond strength of a laminated structure is typically 35-55 N/m, which can exceed the cohesive integrity of the light modulating layer 30.

The invention has been described in detail with particular reference to certain preferred embodiments thereof, but it will be understood that variations and modifications can be effected within the spirit and scope of the invention.

### Parts List

10 sheet

15 substrate

16 second substrate

20 first electrode

30 light modulating layer

31 oversized domains

33 coating defect

35 protective layer

40 second electrode

54 incident light

58 scattered light

What is claimed is:

1. A method of making a liquid crystal display, comprising the steps of:
(a) providing a substrate;
(b) providing a first electrode over the substrate;
(c) coating the first electrode with aqueous dispersed material which when dried provides a dielectric layer over the first electrode;
(d) coating the dielectric layer with liquid crystal bearing material and drying such liquid crystal bearing material;
(e) providing a second separate substrate;
(f) providing a second electrode over the second substrate; and
(g) laminating the second electrode to the coated liquid crystal bearing material using heat and pressure only.

2. The method of claim 1 wherein the interfacial lamination temperature is between 90 and 120° C.

3. The method of claim 1 wherein the binder for the liquid crystal layer is gelatin.

4. The method of claim 1 wherein the liquid crystal material is cholesteric liquid crystal material.

5. The method of claim 1 wherein the second electrode material is indium tin oxide.
